(19) United States
(12) Patent Application Publication
(10) Pub. No.: US 2018/0253612 A1
(43) Pub. Date: Sep. 6, 2018

(54) SIGN RECOGNITION AND DISPLAY DEVICE

(71) Applicant: MAZDA MOTOR CORPORATION, Hiroshima (JP)

(72) Inventors: Kanichi KOYAMA, Aki-gun (JP); Tetsuhiro YAMASHITA, Aki-gun (JP)

(73) Assignee: MAZDA MOTOR CORPORATION, Hiroshima (JP)

(21) Appl. No.: 15/757,009

(22) PCT Filed: Aug. 18, 2016
(86) PCT No.: PCT/JP2016/003770

§ 371 Date: Mar. 2, 2018

(30) Foreign Application Priority Data
Sep. 15, 2015 (JP) 2015-182141

(51) Int. Cl. G06K 9/00; B60W 30/14; B60W 50/14; B60W 50/00; G08G 1/0967

(52) U.S. Cl. CPC G06K 9/00818; B60W 30/146; B60W 50/14; B60W 50/0098; B60W 2050/146; B60W 2420/42; B60W 2550/22; B60W 2720/10; G08G 1/096725

(57) ABSTRACT

The sign recognition and display device includes an camera taking an image of an area in front of the subject vehicle; a sign recognition unit recognizing a road sign included in the image taken by the camera, a display control unit displaying, if a road sign indicating a speed limit is recognized by the sign recognition unit, the speed limit through a display unit; and an intention determination unit determining whether a driver intends to change a vehicle speed to bring the vehicle speed of a subject vehicle toward the speed limit displayed by the display device, wherein the display control unit finishes display of the speed limit if the intention determination unit determines that the driver does not intend to change the vehicle speed.

### TECHNICAL FIELD

The present invention relates to a sign recognition and display device, and more particularly relates to a sign recognition and display device that recognizes a road sign present in front of a subject vehicle and displays information on the road sign.

### BACKGROUND ART

A suggestion has been made to take an image of an area in front of a vehicle with a camera and obtain, based on the taken image, information required to support vehicle operation.

For example, a sign information output device of Patent Document 1 outputs sign information about a sign provided around a road and detected from an image taken by a camera of a vehicle, and stops outputting the sign information if the driving distance exceeds a threshold value after the sign detection. This avoids output of past sign information different from the sign information associated with the current scene.

A sign information output device of Patent Document 2 outputs sign information about a sign provided around a road and detected from an image taken by a camera of a vehicle, and stops output of the sign information based on the vehicle's yaw rate. Then, when the vehicle has changed the direction, the output of the sign information is stopped.

### CITATION LIST

### Patent Documents

PATENT DOCUMENT 1: Japanese Unexamined Patent Publication No. 2015-28738

PATENT DOCUMENT 2: Japanese Unexamined Patent Publication No. 2015-35165

### SUMMARY OF THE INVENTION

### Technical Problem

If there is another road adjacent to the road on which the subject vehicle is driving, the typical devices as described above might extract a road sign provided on the adjacent road from an image taken by a camera mounted on the vehicle. In this case, if the road sign extracted from the image is displayed on the display device, the driver might recognize erroneous information. For example, suppose that there is an ordinary road adjacent to the expressway on which the vehicle is driving, and a speed limit sign provided on the ordinary road is extracted from an image taken by a camera mounted on the vehicle and is displayed on the display device. In this case, the road sign is displayed to indicate the speed limit different from the one of the expressway on which the vehicle is driving. Such a situation makes the driver feel unnatural or annoyed.

In view of the foregoing, it is an object of the present invention to provide a sign recognition and display device which allows a driver to feel less unnatural or annoyed even if a road sign on another road adjacent to the road on which the vehicle is driving is recognized.

### Solution to the Problem

To achieve the object, the sign recognition and display device of the present invention is a sign recognition and display device that recognizes a road sign present in front of a subject vehicle and displays information on the road sign, the device comprising: an image taking unit taking an image of an area in front of the subject vehicle; a sign recognition unit recognizing a road sign included in the image taken by the image taking unit; a display unit displaying, if a road sign indicating a speed limit is recognized by the sign recognition unit, the speed limit indicated by the road sign; and an intention determination unit determining whether a driver intends to change a vehicle speed to bring the vehicle speed of a subject vehicle toward the speed limit displayed by the display unit, wherein the display unit finishes display of the speed limit if the intention determination unit determines that the driver does not intend to change the vehicle speed.

In the invention configured as described above, if the road sign indicating the speed limit is recognized by the image taking unit, the display unit display the speed limit indicated by the road sign. After that, if it is determined that the driver does not intend to change the vehicle speed to bring the vehicle speed of the subject vehicle toward the speed limit displayed by the display unit, the display of the speed limit is finished. Thus, if the speed limit displayed by the display unit might be different from the speed limit of the road on which the subject vehicle is driving, the display of the speed limit can be finished because the driver does not intend to change the vehicle speed. This can make the driver feel less unnatural or annoyed.

In the present invention, preferably, the intention determination unit determines that the driver does not intend to change the vehicle speed if a difference between the vehicle speed of the subject vehicle and the speed limit displayed by the display unit is larger than a predetermined value.

In the invention configured as described above, the intention determination unit determines that the driver does not intend to change the vehicle speed if a difference between the vehicle speed of the subject vehicle and the speed limit displayed by the display unit is larger than a predetermined value. Thus, the intention determination unit can accurately determine whether the driver intends to change the vehicle speed to bring the vehicle speed of the subject vehicle toward the speed limit displayed by the display unit. Thus, if the speed limit displayed by the display unit is different from the speed limit of the road on which the subject vehicle is driving, the display of the speed limit can be reliably finished.

In the present invention, preferably, the intention determination unit determines that the driver does not intend to change the vehicle speed if the difference between the vehicle speed of the subject vehicle and the speed limit displayed by the display unit is larger than the predetermined value when a predetermined time has passed since the display unit started displaying the speed limit.

In the invention configured as described above, the intention determination unit determines that the driver does not intend to change the vehicle speed if the difference between the vehicle speed of the subject vehicle and the speed limit displayed by the display unit is larger than the predetermined value when a predetermined time has passed since the display unit started displaying the speed limit. Thus, the intention determination unit can determine whether the driver intends to change the vehicle speed after a lapse of time enough to make the difference between the vehicle speed of the subject vehicle and the speed limit displayed by the display unit equal to or lower than the predetermined value if the driver intends to change the vehicle speed. Thus, the intention determination unit can more accurately determine whether the driver intends to change the vehicle speed.

In the present invention, preferably, the intention determination unit determines that the driver does not intend to change the vehicle speed if the difference between the vehicle speed of the subject vehicle and the speed limit displayed by the display unit is increasing.

In the invention configured as described above, the intention determination unit determines that the driver does not intend to change the vehicle speed if the difference between the vehicle speed of the subject vehicle and the speed limit displayed by the display unit is increasing. Thus, the intention determination unit can accurately determine whether the driver intends to change the vehicle speed to bring the vehicle speed of the subject vehicle toward the speed limit displayed by the display unit. Thus, if the speed limit displayed by the display unit is different from the speed limit of the road on which the subject vehicle is driving, the display of the speed limit can be reliably finished.

In the present invention, preferably, the sign recognition and display device further includes a speed control system increasing or decreasing the vehicle speed of the subject vehicle to keep the vehicle speed at a level of a target speed, wherein the intention determination unit determines that the driver does not intend to change the vehicle speed if a difference between the target speed and the speed limit displayed by the display unit is larger than a predetermined value.

In the invention configured as described above, the intention determination unit determines that the driver does not intend to change the vehicle speed if a difference between the target speed of the speed control system and the speed limit displayed by the display unit is larger than a predetermined value. Thus, the intention determination unit can accurately determine whether the driver intends to change the vehicle speed to bring the vehicle speed of the subject vehicle toward the speed limit displayed by the display unit. Thus, if the speed limit displayed by the display unit is different from the speed limit of the road on which the subject vehicle is driving, the display of the speed limit can be reliably finished.

### Advantages of the Invention

The sign recognition and display device of the present invention allows a driver to feel less unnatural or annoyed even if a road sign on another road adjacent to the road on which the vehicle is driving is recognized.

### BRIEF DESCRIPTION OF THE DRAWINGS

FIG. 1 is a block diagram showing an electrical configuration of a sign recognition and display device according to an embodiment of the present invention.

FIG. 2 is a flowchart of a speed limit display process in which the sign recognition and display device according to the embodiment of the present invention displays a speed limit.

FIG. 3 is a table showing decision conditions on which the sign recognition and display device of the embodiment of the invention depends to determine whether a driver intends to change a vehicle speed.

### DESCRIPTION OF EMBODIMENTS

A sign recognition and display device according to an embodiment of the present invention will now be described with reference to the attached drawings.

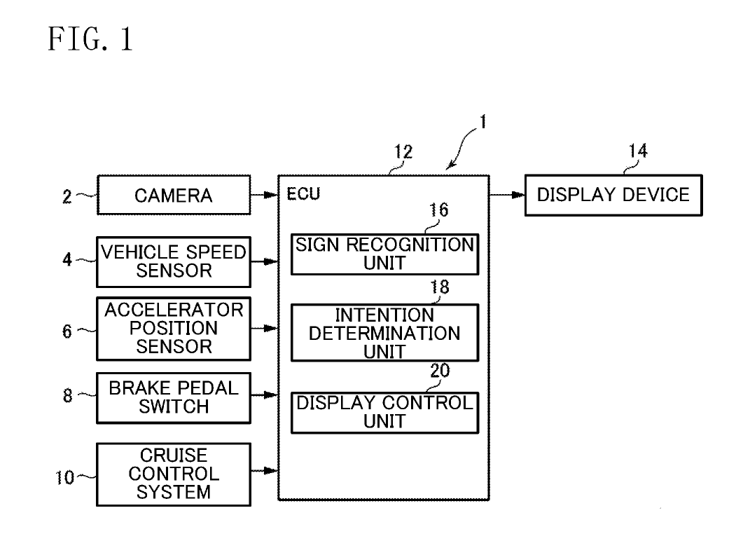

First, a configuration for the sign recognition and display device according to the embodiment of the present invention will be described with reference to FIG. 1.

FIG. 1 is a block diagram showing an electrical configuration of the sign recognition and display device according to the embodiment of the present invention.

In FIG. 1, the reference numeral 1 denotes the sign recognition and display device according to the embodiment of the present invention. The sign recognition and display device 1 includes a camera 2 taking an image of an area in front of a subject vehicle, a vehicle speed sensor 4 detecting a vehicle speed pulse obtained in response to movement of the subject vehicle, an accelerator position sensor 6 detecting an accelerator position, a brake pedal switch 8 detecting a brake pedal operation, and a cruise control system 10. The image data taken by the camera 2, the detection signals by the sensors, and the information output from the cruise control system 10 are input to an electronic control unit (ECU) 12. The sign recognition and display device 1 further includes a display device 14 that displays various pieces of information output from the ECU 12.

The camera 2 is installed in the vehicle to face toward the front of the vehicle including the sign recognition and display device 1, takes an image, and outputs the taken image data to the ECU 12. Examples of the camera 2 include a camera including a CMOS image sensor or a CCD image sensor as an imaging device.

The cruise control system 10 controls an engine and a brake to increase or decrease a vehicle speed of the subject vehicle to keep the vehicle speed at a level of a target speed. The target speed is programmed through, e.g., a control switch.

The display device 14 is disposed within a driver's field of view in a front portion of a passenger compartment. Examples of the display device 14 include a liquid crystal display, and a head-up display.

The ECU 12 includes a sign recognition unit 16 recognizing a road sign included in the image taken by the camera 2, an intention determination unit 18 determining whether a driver intends to change a vehicle speed, and a display control unit 20 allowing the display device 14 to display a speed limit.

Based on the vehicle speed, the increase or decrease in the vehicle speed of the subject vehicle and/or a target speed of the cruise control system 10, and the speed limit indicated by the road sign recognized by the sign recognition unit 16, the intention determination unit 18 determines whether a driver intends to change a vehicle speed to bring the vehicle speed of the subject vehicle toward a speed limit indicated by a road sign.

These elements of the ECU 12 are each configured as a computer including a central processing unit (CPU), various programs interpreted and executed by the CPU (including a basic control program, such as an operating system (OS), and an application launched by the OS to achieve a specific function), and an internal memory, such as a read-only memory (ROM) or a random access memory (RAM), for storing programs and various data.

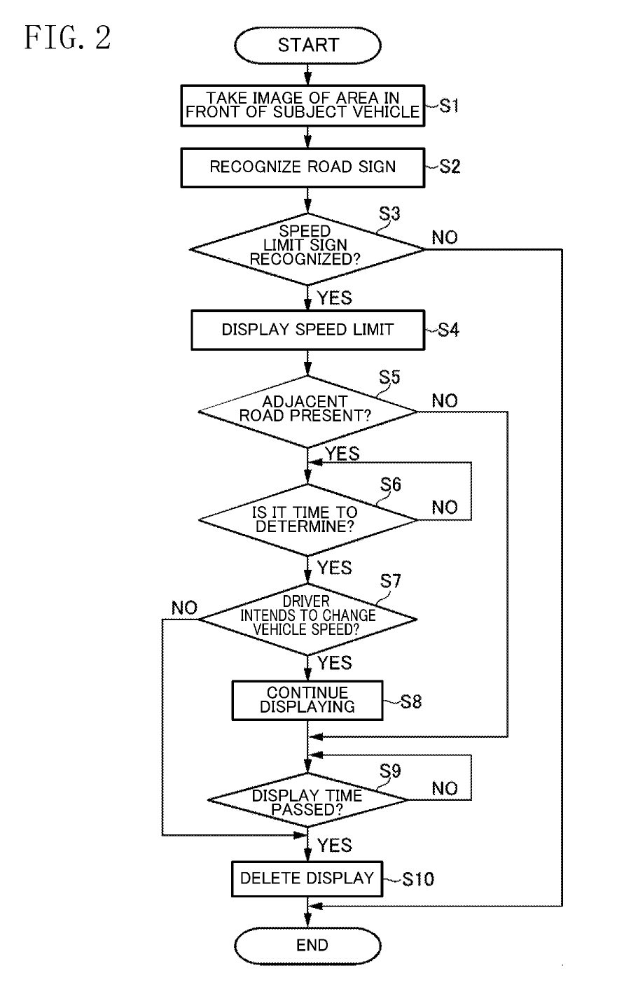

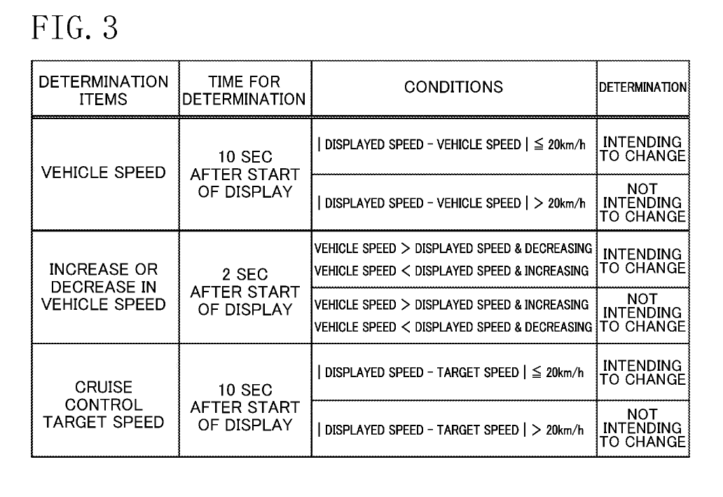

Next, a process performed by the sign recognition and display device 1 will be described with reference to FIGS. 2 and 3.

FIG. 2 is a flowchart of a speed limit display process in which the sign recognition and display device 1 according to the embodiment of the present invention displays a speed limit. FIG. 3 is a table showing decision conditions on which the sign recognition and display device 1 of the embodiment of the invention depends to determine whether a driver intends to change a vehicle speed.

If an ignition of the vehicle is turned on, and the sign recognition and display device 1 is powered, the speed limit display process is started and repeatedly performed.

As shown in FIG. 2, upon the start of the speed limit display process, in Step S1, the camera 2 takes an image of an area in front of the subject vehicle, and outputs the taken image data to the ECU 12.

Next, in Step S2, the sign recognition unit 16 recognizes a road sign included in the image taken by the camera 2. For example, the sign recognition unit 16 recognizes the presence or absence of a road sign, and what the road sign indicates, if present, based on the outline and coloration of objects included in the image data, and the presence or absence of characters.

Next, in Step S3, the display control unit 20 determines whether or not the sign recognition unit 16 has recognized a road sign indicating the speed limit (hereinafter referred to as the “speed limit sign”).

Then, if the sign recognition unit 16 has not recognized the speed limit sign, the sign recognition and display device 1 terminates the speed limit display process without allowing the display device 14 to display the speed limit.

If, in step S2, the sign recognition unit 16 has recognized the speed limit sign, the process proceeds to step S4. In step S4, the display control unit 20 shows, on the display device 14, the speed limit indicated by the speed limit sign that has been recognized by the sign recognition unit 16 in Step S2.

Next, in Step S5, the display control unit 20 determines the presence or absence of a road (hereinafter referred to as the “adjacent road”) adjacent to the road on which the subject vehicle is driving. For example, based on the road information obtained from a navigation system, the display control unit 20 determines the presence or absence of the adjacent road.

Then, if the adjacent road is present, the process proceeds to Step S6. In Step 6, the intention determination unit 18 is on standby until the time has come when the intention determination unit 18 determines whether a driver intends to change a vehicle speed to bring the vehicle speed of the subject vehicle toward the speed limit (the speed limit indicated by the speed limit sign recognized by the sign recognition unit 16) displayed in Step S4.

As shown in FIG. 3, For the determination of whether the driver intends to change the vehicle speed based on the vehicle speed of the subject vehicle and the target speed of the cruise control system 10, the intention determination unit 18 determines that the time when to determine whether the driver intends to change the vehicle speed has come, when 10 seconds has passed since the display device 14 started displaying the speed limit. For the determination of whether the driver intends to change the vehicle speed based on the increase or decrease in the vehicle speed of the subject vehicle, the intention determination unit 18 determines that the time when to determine whether the driver intends to change the vehicle speed has come, when 2 seconds has passed since the display device 14 started displaying the speed limit.

If, in Step S6, the time when to determine whether the driver intends to change the vehicle speed has come, the process proceeds to Step S7. In Step S7, the intention determination unit 18 determines whether the driver intends to change the vehicle speed to bring the vehicle speed of the subject vehicle toward the speed limit displayed in Step S4.

Specifically, as shown in FIG. 3, For the determination of whether the driver intends to change the vehicle speed based on the vehicle speed of the subject vehicle, the intention determination unit 18 determines that the driver intends to change the vehicle speed when the difference between the vehicle speed of the subject vehicle and the speed limit displayed by the display device 14 is less than or equal to 20 km/h, and determines that the driver does not intend to change the vehicle speed when the difference between the vehicle speed of the subject vehicle and the speed limit displayed by the display device 14 is more than 20 km/h.

For the determination of whether the driver intends to change the vehicle speed based on the increase or decrease in the vehicle speed of the subject vehicle, the intention determination unit 18 determines that the driver intends to change the vehicle speed when the vehicle speed of the subject vehicle is more than the speed limit displayed by the display device 14, and the vehicle speed of the subject vehicle is decreasing (for example, the brake pedal switch 8 detects that the brake pedal is being operated); or when the vehicle speed of the subject vehicle is less than the speed limit displayed by the display device 14, and the vehicle speed of the subject vehicle is increasing (for example, the accelerator position sensor 6 detects that the accelerator pedal is being depressed). In other words, the intention determination unit 18 determines that the driver intends to change the vehicle speed when the difference between the vehicle speed of the subject vehicle and the speed limit displayed by the display device 14 is decreasing.

In contrast, the intention determination unit 18 determines that the driver does not intend to change the vehicle speed when the vehicle speed of the subject vehicle is more than the speed limit displayed by the display device 14, and the vehicle speed of the subject vehicle is increasing; or when the vehicle speed of the subject vehicle is less than the speed limit displayed by the display device 14, and the vehicle speed of the subject vehicle is decreasing. In other words, the intention determination unit 18 determines that the driver does not intend to change the vehicle speed when the difference between the vehicle speed of the subject vehicle and the speed limit displayed by the display device 14 is increasing.

For the determination of whether the driver intends to change the vehicle speed based on the target speed of the cruise control system 10, the intention determination unit 18 determines that the driver intends to change the vehicle speed when the difference between the target speed of the cruise control system 10 and the speed limit displayed by the display device 14 is less than or equal to 20 km/h, and determines that the driver does not intend to change the vehicle speed when the difference between the target speed and the speed limit displayed by the display device 14 is more than 20 km/h.

The intention determination unit 18 can determine whether the driver intends to change the vehicle speed as described above based on any of the vehicle speed of the subject vehicle, the increase or decrease in the vehicle speed of the subject vehicle, and the target speed of the cruise control system 10; or any combination thereof.

If, in Step S7, it is determined that the driver intends to change the vehicle speed to bring the vehicle speed of the subject vehicle toward the speed limit displayed in Step S4, the process proceeds to Step S8. In Step S8, the display control unit 20 makes the display device 14 continue to display the speed limit indicated by the speed limit sign recognized by the sign recognition unit 16 in Step S2.

If it is determined after Step S8 or in Step S5 that no adjacent road is present, the process proceeds to Step S9. In Step S9, the display control unit 20 is on standby until a predetermined display time (e.g., 30 seconds) has passed since the display device 14 started displaying the speed limit.

Then, when the predetermined display time has passed since the display device 14 started displaying the speed limit, the process proceeds to Step S10. In Step S10, the display control unit 20 makes the display device 14 delete the speed limit indicated by the speed limit sign recognized by the sign recognition unit 16 in Step S2.

If, it is determined in Step S7 that the driver does not intend to change the vehicle speed to bring the vehicle speed of the subject vehicle toward the speed limit displayed in Step S4, it is presumed that the sign recognition unit 16 recognizes the road sign provided on the adjacent road, and the display device 14 displays a speed limit different from the speed limit of the road on which the subject vehicle is driving. Then, the process proceeds to Step S10. In Step S10, the display control unit 20 makes the display device 14 delete the speed limit indicated by the speed limit sign recognized by the sign recognition unit 16 in Step S2.

After Step S10, the sign recognition and display device 1 finishes the speed limit display process.

Next, advantages of the sign recognition and display device 1 according to the foregoing embodiment of the present invention will be described.

First, if the road sign indicating the speed limit is recognized from the image data taken by the camera 2, the display control unit 20 makes the display device 14 display the speed limit indicated by the road sign. After that, if it is determined that the driver does not intend to change the vehicle speed to bring the vehicle speed of the subject vehicle toward the speed limit displayed by the display device 14, the display of the speed limit is finished. Thus, if the speed limit displayed by the display device 14 might be different from the speed limit of the road on which the subject vehicle is driving, the display of the speed limit can be finished because the driver does not intend to change the vehicle speed. This can make the driver feel less unnatural or annoyed.

The intention determination unit 18 determines that the driver does not intend to change the vehicle speed if the difference between the vehicle speed of the subject vehicle and the speed limit displayed by the display device 14 is larger than a predetermined value. Thus, the intention determination unit 18 can accurately determine whether the driver intends to change the vehicle speed to bring the vehicle speed of the subject vehicle toward the speed limit displayed by the display device 14. Thus, if the speed limit displayed by the display device 14 is different from the speed limit of the road on which the subject vehicle is driving, the display of the speed limit can be reliably finished.

The intention determination unit 18 determines that the driver does not intend to change the vehicle speed if the difference between the vehicle speed of the subject vehicle and the speed limit displayed by the display device 14 is larger than a predetermined value when the predetermined time has passed since the display device 14 started displaying the speed limit. Thus, the intention determination unit 18 can determine whether the driver intends to change the vehicle speed after a lapse of time enough to make the difference between the vehicle speed of the subject vehicle and the speed limit displayed by the display device 14 equal to or lower than the predetermined value if the driver does not intend to change the vehicle speed. Thus, the intention determination unit 18 can more accurately determine whether the driver intends to change the vehicle speed.

The intention determination unit 18 determines that the driver does not intend to change the vehicle speed if the difference between the vehicle speed of the subject vehicle and the speed limit displayed by the display device 14 is increasing. Thus, the intention determination unit 18 can accurately determine whether the driver intends to change the vehicle speed to bring the vehicle speed of the subject vehicle toward the speed limit displayed by the display device 14. Thus, if the speed limit displayed by the display device 14 is different from the speed limit of the road on which the subject vehicle is driving, the display of the speed limit can be reliably finished.

The intention determination unit 18 determines that the driver does not intend to change the vehicle speed if the target speed of the cruise control system 10 and the speed limit displayed by the display device 14 is larger than a predetermined value. Thus, the intention determination unit 18 can accurately determine whether the driver intends to change the vehicle speed to bring the vehicle speed of the subject vehicle toward the speed limit displayed by the display device 14. Thus, if the speed limit displayed by the display device 14 is different from the speed limit of the road on which the subject vehicle is driving, the display of the speed limit can be reliably finished.

### DESCRIPTION OF REFERENCE CHARACTERS

1 Sign Recognition And Display Device
2 Camera
4 Vehicle Speed Sensor
6 Accelerator Position Sensor
8 Brake Pedal Switch
10 Cruise Control System
12 ECU
14 Display Device
16 Sign Recognition Unit
18 Intention Determination Unit
20 Display Control Unit

1. A sign recognition and display device that recognizes a road sign present in front of a subject vehicle and displays information on the road sign, the device comprising:
an image taking unit taking an image of an area in front of the subject vehicle;
a sign recognition unit recognizing a road sign included in the image taken by the image taking unit;
a display unit displaying, if a road sign indicating a speed limit is recognized by the sign recognition unit, the speed limit indicated by the road sign; and
an intention determination unit determining whether a driver intends to change a vehicle speed to bring the vehicle speed of a subject vehicle toward the speed limit displayed by the display unit,
wherein
the display unit finishes display of the speed limit if the intention determination unit determines that the driver does not intend to change the vehicle speed.

2. The sign recognition and display device of claim 1, wherein
the intention determination unit determines that the driver does not intend to change the vehicle speed if a difference between the vehicle speed of the subject vehicle and the speed limit displayed by the display unit is larger than a predetermined value.

3. The sign recognition and display device of claim 2, wherein
the intention determination unit determines that the driver does not intend to change the vehicle speed if the difference between the vehicle speed of the subject vehicle and the speed limit displayed by the display unit is larger than the predetermined value when a predetermined time has passed since the display unit started displaying the speed limit.

4. The sign recognition and display device of claim 1, wherein
the intention determination unit determines that the driver does not intend to change the vehicle speed if the difference between the vehicle speed of the subject vehicle and the speed limit displayed by the display unit is increasing.

5. The sign recognition and display device of claim 1, further comprising:
a speed control system increasing or decreasing the vehicle speed of the subject vehicle to keep the vehicle speed at a level of a target speed,
wherein
the intention determination unit determines that the driver does not intend to change the vehicle speed if the difference between the target speed and the speed limit displayed by the display unit is larger than a predetermined value.
